(19) United States
(12) Patent Application Publication
(10) Pub. No.: US 2016/0069468 A1
(43) Pub. Date: Mar. 10, 2016

(54) VACUUM VALVE

(71) Applicant: VAT HOLDING AG, Haag (CH)

(72) Inventor: Mathias SCHÖN, Salez (CH)

(21) Appl. No.: 14/778,561

(22) PCT Filed: Mar. 12, 2014
(86) PCT No.: PCT/EP2014/054818

§ 371 Date: Sep. 18, 2015

(30) Foreign Application Priority Data
Mar. 21, 2013 (EP) 13160432.4

(51) Int. Cl. F16K 31/122

(52) U.S. Cl. CPC F16K 31/122

(57) ABSTRACT

Some embodiments of the invention relate to a vacuum valve having at least one piston/cylinder arrangement for adjusting a first closure member between a first, a second, and a middle closure member position. In some embodiments, the piston/cylinder arrangement which is coupled mechanically to the first closure member has a cylinder unit and a piston unit. A first seal body and a second seal body can be displaced independently of one another axially relative to the cylinder unit and to the piston unit. A first axial stop of the cylinder unit and a third axial stop of the piston unit are arranged relative to one another such that, in the middle closure member position, the axial movability of the first seal body in the direction of a second pressure chamber is limited jointly by the first axial stop and the third axial stop.

The invention relates to a vacuum valve according to the preamble of claim 1.

Vacuum valves for the substantially gas-tight closure of a flow path leading through at least one opening formed in a valve wall or a valve body are known in different embodiments from the prior art.

Vacuum valves are used in particular in the field of IC and semiconductor manufacture, which must take place in a protected atmosphere, where possible without the presence of contaminating particles. By way of example, in a manufacturing facility for semiconductor wafers or liquid crystal substrates, the highly sensitive semiconductor or liquid crystal elements pass sequentially through a plurality of process chambers, in each of which the semiconductor elements located within the respective process chamber are processed by means of a processing device. Both during the processing process within the process chamber and during the transport from process chamber to process chamber, the highly sensitive semiconductor elements must always be located in a protected atmosphere, in particular in a vacuum. The process chambers are interconnected for example via connecting passages, wherein the process chambers can be opened by means of vacuum gate valves in order to transfer the parts from one process chamber to the next and can then be closed in a gas-tight manner in order to perform the respective manufacturing step. Valves of this type are also referred to as vacuum transfer valves on account of the described field of application and are also referred to as rectangular gates on account of their rectangular opening cross section.

The evacuation of the chambers or the supply and removal of process gases is performed via feed lines and discharge lines, which in particular can be closed in a gas-tight manner likewise by means of vacuum valves, such as gate valves, shuttle valves, or angle valves in the form of what are known as peripheral valves.

With the use of vacuum valves in the field of production of highly sensitive semiconductor elements, the particle generation, caused in particular by the actuation of the valve, and the number of free particles in the vacuum region of the valve chamber must be kept as low as possible. The particle generation is primarily a result of friction, for example by metal-metal contact and by abrasion. Above all, pneumatic drives, particularly linear drives in the form of piston-cylinder arrangements, have become established as suitable drives for use in the vacuum region.

The opening to be closed can be sealed for example either via a seal arranged on the closure side of the closure member, which seal is pressed against the valve seat running around the opening, or via a seal, in particular a ring seal, on the valve seat, against which seal the closure side of the closure member is pressed. Different sealing devices are known from the prior art, for example from U.S. Pat. No. 6,629,682 B2 (Duelli). A suitable material for ring seals is, for example, the resilient seal material known under the trade name Viton®.

Different embodiments of vacuum valves, in particular of the drive technology thereof, are known from the prior art and have the objective, inter alia, of increasing the service life of the used seals as well as providing improved process reliability.

Depending on the respective drive technology, a distinction is made in particular between gate valves, also referred to as valve gates or rectangular gates, and shuttle valves, wherein the closing and opening is usually performed in two steps in the prior art. In a first step a valve closure member, in particular a closure disk, in the case of a gate valve as is known for example from U.S. Pat. No. 6,416,037 (Geiser) or U.S. Pat. No. 6,056,266 (Blecha), in particular of the L-type, is displaced linearly over an opening substantially parallel to the valve seat, or, in the case of a shuttle valve as known for example from U.S. Pat. No. 6,089,537 (Olmsted), is pivoted about a pivot axis over the opening, without there being any contact between the closure disk and the valve seat of the valve body. In a second step the closure disk is pressed via the closure side thereof against the valve seat of the valve body, such that the opening is closed in a gas-tight manner.

Besides the possibility of a precise control of the flow rate, the described two-stage movement, in which the closure member is first slid transversely over the opening and is then pressed substantially perpendicularly against the valve seat, also has the advantage, above all, that the seal is pressed practically exclusively perpendicularly, with no transverse or longitudinal stressing of the seal.

The closure movement of a gate valve or of a shuttle valve performed in two steps may be performed in particular by means of a single drive or by means of two separate drives.

Drive mechanisms that by means of a single drive element enable both a substantially linear displacement of the closure disk over the opening and a substantially perpendicular pressing of the closure disk against the valve seat running around the opening are known for example from U.S. Pat. No. 6,431,518 B1, U.S. Pat. No. 5,415,376 A, U.S. Pat. No. 5,641,149 A, U.S. Pat. No. 6,045,117 A, U.S. Pat. No. 5,934,646 A, U.S. Pat. No. 5,755,255 A, U.S. Pat. No. 6,082,706, U.S. Pat. No. 6,095,180, and U.S. Pat. No. 6,629,682 B2.

However, the two-stage movement process may also be attained by means of a plurality of separate drive mechanisms or drive elements. By way of example, U.S. Pat. No. 6,056,266 (Blecha) and U.S. Pat. No. 6,561,484 (Nakagawa) describe gate valves of which the push rods are linearly movable along the push rod axis, whereby the closure disk can be slid in parallel over the opening without resulting in any contact between the closure disk and the valve seat. The drive mechanism may be formed in this case by a simple linear movement drive, for example a piston-cylinder drive. The closure disk is pressed against the valve seat by a separate drive in the closure disk, which is divided into two parts, or between the closure disk and the push rod. This separate drive is formed in particular as a piston-cylinder drive, by means of which the closure side of the closure disk can be pressed in a straight line perpendicularly against the valve seat, as shown in U.S. Pat. No. 6,056,266 (Blecha).

A similar vacuum valve having two separate drive elements is shown in DE 10 2007 030 006 A1. In order to displace the valve stem in the longitudinal direction thereof, a piston-cylinder arrangement is used, which is mounted so as to be displaceable in parallel as a whole in relation to the valve body in a direction transverse to the longitudinal axis of the valve stem. A further piston-cylinder arrangement, likewise arranged outside the vacuum region, is used for the parallel displacement.

DE 10 2008 049 353 A1 (Ehrne, Blecha) describes a vacuum valve of which the valve stem is guided out from the vacuum region and is connected outside the vacuum region both to a longitudinal drive arrangement and to a separate transverse drive arrangement and also a bearing unit.

In the vacuum valve known from WO 2010/034046 A1 the valve stem, in order to close the vacuum valve, is firstly displaced in the direction of the longitudinal axis of said valve stem, and the valve stem is then displaced in parallel transversely to the longitudinal axis thereof. For this purpose the valve stem is mounted displaceably in the direction of its longitudinal axis by a bearing unit arranged outside the vacuum region. The bearing unit may be displaced jointly with the valve stem, transversely hereto. Piston-cylinder arrangements that act in this transverse direction are used for this purpose. In other exemplary embodiments the piston-cylinder arrangements act in the direction of the longitudinal axis of the valve stem, wherein the transverse movement of the bearing unit is produced by means of guide rods, which form a parallelogram guide.

A disadvantage of some vacuum valves, of which the closure member can be moved firstly transversely over the valve seat and then perpendicularly against the valve seat by a two-stage, in particular L-shaped movement, lies in the fact that they generally have a high load-bearing capacity only in one seal direction. If a relative negative pressure prevails on the opening side, toward which the closure side of the closure member is directed, the closure member will be pressed against the valve seat on account of the pressure difference and will be supported by this valve seat. In this case the pressure acts in the same closing direction as the drive itself. Measures for avoiding an excessive pressing of the seal between the valve seat and the closure side of the closure member, which excessive pressing would damage the seal, are known from the prior art. The vacuum valve may therefore absorb a high relative negative pressure on the opening side. If, by contrast, a relative overpressure prevails on the opening side or, in other words, a relative negative pressure prevails on the closure member side, the pressure acts against the closing direction of the drive, and the closure member is pushed away from the valve seat on account of the pressure difference. Without further measures the closure member would lift away from the valve seat, and the valve would open. If the vacuum valve is to be able to be loaded from each side, measures for supporting the closure member in the opposite closing direction must be taken in particular, such that the closure member is pressed with sufficient force against the valve seat in spite of counteracting pressure. A support of this type can be provided by sufficiently dimensioned drive and support elements, as are known in different form from the prior art.

Alternatively, instead of a single closure member closing in one direction, two closure members movable in a manner dependent on one another or independent of one another and closing in opposite directions are used in order to close two opposite valve openings.

For this reason, double-plate or twin-plate valves are routinely used in applications in which a switch is made between high relative overpressure and negative pressure. In the case of double- or twin-plate valves of this type a first closure plate side may be pressed in a first direction against a first valve seat extending annularly around the first valve opening, and an opposite second closure plate side may be pressed in an opposite second direction against an opposite second valve seat extending annularly around the second valve opening. The opposite openings may be closed alternately in the case of coupled closure plates or a single closure plate having two closure sides, or simultaneously in the case of independently movable closure plates. Certain embodiments provide a spreading mechanism for pressing the closure plates away from one another and for pressing each closure plate against the respective valve seat.

Vacuum valves that have a valve body with an interior forming a vacuum region of the vacuum valve, with first and second valve openings, which have parallel longitudinal axes and are surrounded by first and second valve seats, are known from the prior art. A closure member comprises first and second closure plates. By means of a transverse drive the closure member is movable in an actuation direction transverse to the longitudinal axes of the valve openings, i.e. the opening axis, between an open position, in which the closure plates release the valve openings, and an intermediate position, in which the closure plates cover the valve openings, but are lifted from the valve seats. In addition, a first longitudinal drive for moving the closure member between the intermediate position and a first closing position, in which the first closure plate is pressed against the first valve seat, is provided. With the aid of a second longitudinal drive, the closure member can be moved between the intermediate position and a second closing position, in which the second closure plate is pressed against the second valve seat.

A vacuum valve of the type mentioned in the introduction is known from U.S. Pat. No. 6,390,448 B1. A closure member of this vacuum valve has first and second closure plates, which can be pressed alternately against first and second valve seats, which surround first and second valve openings. By means of a transverse drive the closure member can be moved transversely to the longitudinal axes of the valve openings between an open position and an intermediate position, in which the closure plates cover the valve openings, but are lifted from the valve seats. The transverse drive is mounted on a pivot part pivotable about an axis. By means of a drive element the pivot part can be pivoted about its pivot axis in order to press the first closure plate against the first valve seat. The drive element and the pivot axis for the pivot part are arranged on a further pivot part, which can be pivoted about a further pivot axis by means of a further drive element. By pivoting the further pivot part about the further pivot axis the second closure plate can be pressed against the second valve seat. This design is relatively complex. The vacuum valve is designed for valve openings having relatively small opening widths.

In U.S. Pat. No. 6,776,394 B2 a vacuum valve is described, in which a valve disk is mounted on a pivot arm. The pivot arm is mounted on a shaft that is pivotable about an axis of rotation and that is displaceable in the direction of the axis of rotation. The shaft is guided relative to the valve body by means of a slotted guide. A shank cooperating with the slotted guide, screwed into an internal threat of the shaft, and rotatable by means of a drive element is used in order to displace the shaft in the direction of the axis of rotation and in order to rotate the shaft about the axis of rotation. Furthermore, drive elements in the form of piston-cylinder arrangements are provided in the valve body and cooperate with tappet-like actuation elements introduced into the vacuum region. As a result of this the closure plate can be pressed with an additional force against the valve seat in the closing position of the closure plate.

The vacuum valve known from US 2004/0079915 A1 as a closure member with a carrying part, on which a closure plate is arranged displaceably by means of piston-cylinder arrangements. In the position of the closure member covering the valve opening, the closure plate can be pressed by means of the piston-cylinder arrangement against the valve seat surrounding the valve opening. A support plate is preferably also provided, which is displaceable relative to the carrying part by means of piston-cylinder arrangements, wherein the support plate is pressed in the closing position of the closure plate against an opposite wall of the valve body in a region surrounding a further valve opening. Elastomer rings for cooperating with the wall of the valve body are arranged on the closure plate and on the support plate.

U.S. Pat. No. 6,561,483 (Nakagawa) and U.S. Pat. No. 6,561,484 (Nakagawa et al.) disclose gate valves in different embodiments, which comprise a closure plate divided into two parts. A first disk portion has an opening. A second disk portion is connected by means of a ductile body to the first disk portion. An actuator is arranged between the first and the second disk portion, such that the two disk portions can be moved actively toward one another and away from one another. The ductile body is formed as a bellows. The first disk portion can be pressed by means of the actuator against the valve seat, wherein the second disk portion—in particular in the case of an overpressure on the valve seat side—is supported on an opposite valve body side as necessary.

Linear drives, in particular piston-cylinder drives or spindle drives, are suitable both for the linear or pivoting transverse movement of the closure member over the opening, and for the perpendicular movement of the closure member toward the valve seat, as also in the case of a combined movement process by means of one drive. Spindle drives are suitable above all for the relatively slow, precise linear movement, wherein any intermediate positions can be adopted with self-locking, however these drives have a relatively complex construction. In particular on account of the mechanical sliding connection between spindle and spindle nut, friction particles are produced, such that the drive is to be isolated from the vacuum region of the valve in order to avoid hindering the process.

Piston-cylinder drives, in particular pneumatic or hydraulic, have the advantage of a simple construction, a lower particle production, and a very high movement speed, but intermediate positions above all in the case of pneumatic drives generally can only be accurately adopted and held with additional control effort or use of a plurality of piston-cylinder drives.

However, both in the case of the transverse movement of the closure member transversely over the valve seat and in the case of the perpendicular movement toward the valve seat, the selective, precise and stable movement of the linear drive into at least one intermediate position is necessary or advantageous in certain applications, in particular for setting certain operating states or opening cross sections or for controlling a flow rate.

In particular, but not exclusively in the case of double valves, in which two opposite valve openings can be closed alternately by way of one closure element having two opposite closures sides, a simple drive by means of which a defined intermediate position of the closure element between the first and the second closing position can be adopted accurately, in particular for the reliable execution of the transverse movement, would be of great advantage.

However, also in the case of simpler gate or shuttle valves, in which the closing is performed by means of a transverse and a longitudinal movement, a simple drive by means of which the closure member can be moved into a defined middle position would be advantageous. In the case of use as a transverse drive, the opening cross section could be covered for example in a defined middle position only partially by the closure member. In the case of a longitudinal drive, the closure member could be moved between the intermediate position, in which the closure side is located opposite the valve seat at a distance therefrom, and the gas-tight closed position into a defined middle position in order to further reduce the flow rate compared with the intermediate position.

In the case of piston-cylinder drives of simple construction used in the vacuum region, the adoption of three defined stable positions, which can also be held under action of a counterforce, is possible only with much increased structural outlay.

The object of the invention is therefore to provide a vacuum valve having a closure member that can be moved by means of a piston-cylinder arrangement of simple construction between a stable first closure member position, a stable second closure member position, and a stable middle closure member position arranged therebetween.

This object is achieved by the implementation of the features in the independent claim. Features that develop the invention in an alternative or advantageous manner can be inferred from the dependent claims.

The vacuum valve according to the invention comprises a first closure member and a first drive, which has at least one piston-cylinder arrangement. The first drive is designed to move the first closure member, wherein the piston-cylinder arrangement is mechanically coupled to the first closure member in order to move said first closure member.

The piston-cylinder arrangement has a cylinder unit, a piston unit and a seal unit.

The cylinder unit has a cylinder interior and an inner peripheral surface, wherein the cylinder interior is spanned by the inner peripheral surface and is limited thereby radially in particular. The cylinder interior is limited axially by two cylinder base faces.

The piston unit is located in the cylinder interior and is surrounded, in particular radially, by the inner peripheral surface of the cylinder unit. The piston unit, which is located in particular between the two cylinder base faces, has an outer peripheral surface, of which the shape corresponds at least in a first and second portion substantially to the shape of the inner peripheral surface. The piston unit is limited by the outer peripheral surface and in particular two piston base faces and in particular is solid or hollow. The piston unit, which is closed in particular, can be moved in the cylinder interior linearly relative to the cylinder unit along a geometric piston axis. The inner peripheral surface and the outer peripheral surface extend geometrically along the geometric piston axis, at least in a first and second portion.

In the gap, which in particular is a radial gap, between the inner peripheral surface and the outer peripheral surface the seal unit is arranged sealingly such that a gas-tight contact is produced between the inner peripheral surface and the outer peripheral surface via the seal unit. This seal unit, jointly with the piston unit, thus divides the cylinder interior into a gas-tight first pressure chamber, which extends axially on one side of the piston unit, and a gas-tight second pressure chamber, which extends axially on the other side of the piston unit. The first pressure chamber and the second pressure chamber are thus separated from one another in a gas-tight manner, wherein the piston unit and the seal unit are located as separating members axially between these two pressure chambers.

The at least one piston-cylinder arrangement is mechanically coupled to the first closure member in such a way that the first closure member can be moved between a first closure member position and a second closure member position by changing a pressure difference prevailing between the first pressure chamber and the second pressure chamber. In the first closure member position the cylinder unit and the piston unit are positioned relative to one another in a first relative position to one another. In the second closure member position the cylinder unit and the piston unit are positioned relative to one another in a second relative position to one another. The volume of the first pressure chamber is preferably at a maximum in the first relative position or the second relative position, whereas the volume is at a minimum in the second pressure chamber.

Depending on the effective working surfaces the piston unit is in equilibrium at a certain pressure difference prevailing between the two pressure chambers, in particular a pressure difference equal to zero. By changing this pressure difference in a positive or negative direction, the piston unit is moved relative to the cylinder unit into the first or into the second relative position when a certain threshold has been exceeded. Depending on the type of mechanical coupling, either the cylinder unit or the piston unit is preferably stationary here, wherein the non-stationary element is preferably mechanically coupled to the first closure member. The mechanical coupling between the piston-cylinder arrangement and the first closure member can be provided via a preferably fixed mechanical coupling of the piston unit or of the cylinder unit to the first closure member, for example a connection by way of connecting rods or a hinged connection.

In accordance with the invention the seal unit is formed by a first seal body and a second seal body. These two seal bodies are axially displaceable (at least within a certain movement region) independently of one another both relative to the cylinder unit and relative to the piston unit along the geometric piston axis. In other words the two seal bodies (at least within a certain movement region) can be displaced in a manner decoupled from one another and independently of one another. The two seal bodies form independent movement members in relation to the piston unit and the cylinder unit within this movement region. However, the free movability relative to the cylinder unit and relative to the piston unit is limited to certain relative movement regions by means of a plurality of axial stops, as will be explained in great detail hereinafter.

Both the first seal body and the second seal body have an outer sealing surface and an inner sealing surface. The respective outer sealing surface bears in a gas-tight manner against the inner peripheral surface and is axially displaceable relative to the inner peripheral surface. The respective inner sealing surface also bears in a gas-tight manner against the outer peripheral surface and is axially displaceable relative to the outer peripheral surface. In other words a gas-tight contact is produced between the respective seal bodies and both the inner peripheral surface and the outer peripheral surface by means of the sealing surfaces, wherein a relative axial displaceability is provided whilst maintaining the state sealed in a gas-tight manner.

The outer sealing surface of the first seal body is axially movable relative to the cylinder unit within a first portion of the inner peripheral surface. The outer sealing surface of the second seal carrier is also axially movable relative to the cylinder unit within a second portion of the inner peripheral surface.

The inner sealing surface of the first seal body is axially movable relative to the piston unit within a first portion of the outer peripheral surface. The inner sealing surface of the second seal carrier is also axially movable relative to the piston unit within a second portion of the outer peripheral surface.

In a possible embodiment of the invention the first seal body is formed by a first O-ring, wherein the second seal body is also formed as a second O-ring. The O-rings may have a circular seal cross section, but also any other seal cross section, in particular an oval or polygonal, in particular square, seal cross section. The outwardly pointing surface of the respective O-ring acts in this case as the respective outer sealing surface, whereas the inwardly pointing surface of the respective O-ring acts as the respective inner sealing surface. The O-ring is preferably dimensioned and designed in such a way that it can slide both on the inner peripheral surface and on the outer peripheral surface whilst sealing in a gas-tight manner without, itself, rotating.

Alternatively, however, it is also possible for the first seal body to be formed by a first seal carrier and for the second seal body to be formed by a second seal carrier. The seal carriers by way of example have an annular cross section. The first seal body has an outer seal forming the outer sealing surface and an inner seal forming the inner sealing surface. The second seal body also has an outer seal forming the outer sealing surface and an inner seal forming the inner sealing surface. These outer and inner seals may be formed by way of example by O-rings, which in particular are held is in an internal or external groove in the respective seal carrier, or may be formed by seals vulcanized onto the respective seal carriers.

In accordance with the invention the respective relative movement regions of the two seal bodies are limited to certain regions both relative to the piston unit and relative to the cylinder unit. The seal bodies thus act within certain movement regions as drivers, wherein a force acting on the seal bodies as a result of the pressure in the respective pressure chamber is transmitted to the piston unit and/or to the cylinder unit, such that seal bodies, depending on their relative position, are coupled in one direction either to the cylinder unit or the piston unit by means of stops. A force acting on the respective seal body thus acts either on the piston unit or the cylinder unit, as will be explained hereinafter.

The cylinder unit has a first axial stop and a second axial stop. Both axial stops are coupled axially rigidly to the cylinder unit.

The first axial stop of the cylinder unit limits the axial movability of the first seal body relative to the cylinder unit in the direction of the second pressure chamber to a first portion of the inner peripheral surface arranged on the side of the first pressure chamber. In other words the region of the free axial movability of the first seal body in the direction of the second pressure chamber and in the direction of the second seal body is limited to the inner peripheral surface of the cylinder unit, more specifically to a first portion of the inner peripheral surface.

The second axial stop of the cylinder unit limits the axial movability of the second seal body relative to the cylinder unit in the direction of the first pressure chamber to a second portion of the inner peripheral surface arranged on the side of the second pressure chamber. In other words the second axial stop is arranged on the cylinder unit in such a way that the region of the free axial movability of the second seal body in the direction of the first pressure chamber and in the direction of the first seal body is limited to the inner peripheral surface of the cylinder unit, more specifically to a second portion of the inner peripheral surface.

In a development of the invention the first axial stop and the second axial stop of the cylinder unit are formed by at least one shoulder protruding inwardly into the cylinder interior, said shoulder being arranged between the first portion of the inner peripheral surface and the second portion of the inner peripheral surface and in particular separating these two portions. The side of the inwardly protruding shoulder pointing in the direction of the first pressure chamber acts as a first axial stop, and the side of the inwardly protruding shoulder pointing in the direction of the second pressure chamber acts as a second axial stop. This inwardly protruding shoulder is formed in particular by a collar-shaped tapering, which runs in a ring within the inner peripheral surface (in particular continuously annularly) or is provided in the form of a plurality of shoulders.

In a development of the invention the at least one inwardly protruding shoulder has transitions to the first portion of the inner peripheral surface and the second portion of the inner peripheral surface, wherein the shape of the transitions corresponds to the shape of the first seal body and of the second seal body, such that the seal bodies come to rest uniformly on the shoulder. In the case of O-rings with circular seal cross section, the transitions of the inwardly protruding shoulder correspond substantially to the radius of the O-rings.

The two seal bodies may thus be moved toward one another and away from one another relative to the cylinder unit, wherein the first and the second axial stop of the cylinder unit limit the minimum distance of the two seal bodies from one another. The first and the second axial stop thus divide the inner peripheral surface into a first portion for the first seal body and a second portion for the second seal body.

The piston unit also has two axial stops for the two seal bodies, specifically a third axial stop and a fourth axial stop.

The third axial stop of the piston unit limits the axial movability of the first seal body relative to the piston unit in the direction of the second pressure chamber to a first portion of the outer peripheral surface arranged on the side of the first pressure chamber. In other words the third axial stop is arranged on the piston unit in such a way that the region of the free axial movability of the first seal body in the direction of the second pressure chamber and in the direction of the second seal body is limited to the outer peripheral surface of the piston unit, more specifically to a first portion of the outer peripheral surface.

The fourth axial stop of the piston unit limits the axial movability of the second seal body relative to the piston unit in the direction of the first pressure chamber to a second portion of the outer peripheral surface arranged on the side of the second pressure chamber. In other words the fourth axial stop is arranged on the piston unit in such a way that the region of the free axial movability of the second seal body in the direction of the first pressure chamber and in the direction of the first seal body is limited to the outer peripheral surface of the piston unit, more specifically to a second portion of the outer peripheral surface.

In a development of the invention the third axial stop and the fourth axial stop of the piston unit are formed by at least one outwardly protruding shoulder, which is arranged between the first portion of the outer peripheral surface and the second portion of the outer peripheral surface and in particular separates these two portions from one another. The side of the outwardly protruding shoulder pointing in the direction of the first pressure chamber acts as a third axial stop, and the side of the outwardly protruding shoulder pointing in the direction of the second pressure chamber acts as a fourth axial stop. This outwardly protruding shoulder is formed in particular by a collar-shaped extension, which runs continuously in a ring outside and around the outer peripheral surface or is provided in the form of a plurality of shoulders.

In a further development of the invention the least one outwardly protruding shoulder has transitions to the first portion of the outer peripheral surface and the second portion of the outer peripheral surface, wherein the shape of the transitions corresponds to the shape of the first seal body and of the second seal body, such that the seal bodies come to rest uniformly on the shoulder. In the case of O-rings with circular seal cross section, the transitions of the outwardly protruding shoulder correspond substantially to the radius of the O-rings.

The two seal bodies may thus be moved toward one another and away from one another relative to the piston unit, wherein the third and the fourth axial stop of the piston unit limit the minimum distance of the two seal bodies from one another. The third and the fourth axial stop thus divide the outer peripheral surface into a first portion for the first seal body and a second portion for the second seal body.

The first axial stop of the cylinder unit and the third axial stop of the piston unit are arranged relative to one another in such a way that in a middle relative position of the cylinder unit and of the piston unit relative to one another, said middle relative position lying between the first relative position and the second relative position and corresponding to a middle closure member position, the axial movability of the first seal body in the direction of the second pressure chamber is limited jointly by the first axial stop and the third axial stop.

In other words, in a middle relative position of the cylinder unit and of the piston unit relative to one another the first axial stop of the cylinder unit and the third axial stop of the piston unit lie relative to one another in such a way and are located in particular in such a mutually opposed position that the first and the third axial stop in this middle relative position act as a common axial stop for the first seal body, and the first seal body may rest on both the first axial stop and the third axial stop in the direction of the second pressure chamber and the second seal body.

The second axial stop of the cylinder unit and the fourth axial stop of the piston unit are also arranged relative to one another in such a way that in the middle relative position the axial movability of the second seal body in the direction of the first pressure chamber is limited jointly by the second axial stop and the fourth axial stop.

In other words, in the middle relative position of the cylinder unit and of the piston unit relative to one another the second axial stop of the cylinder unit and the fourth axial stop of the piston unit lie relative to one another in such a way and are located in particular in such a mutually opposed position that the second and the fourth axial stop in this middle relative position act as a common axial stop for the second seal body, and the second seal body may rest on both the second axial stop and also the fourth axial stop in the direction of the first pressure chamber and the first seal body.

The movement regions of the two seal bodies and the portions of the inner and outer peripheral surfaces, as described above, are limited in the direction toward one another by the four axial stops. A limitation outwardly by means of further axial stops, in particular by means of a further four axial stops, is not absolutely necessary, but is possible.

In a development of the invention the first axial stop and the third axial stop in the middle relative position are arranged in a radial mutually opposed position with respect to the piston axis, wherein in this middle relative position the second axial stop and the fourth axial stop are also arranged in a radial mutually opposed position with respect to the piston axis.

In a possible embodiment the cylinder unit with its first portion and its second portion of the inner peripheral surface and also the piston unit with its first portion and its second portion of the outer peripheral surface have a circular cross section in a geometric sectional plane passed through perpendicularly by the geometric piston axis. In other words the first and second portions of the inner and outer peripheral surfaces, over which the outer and inner sealing surfaces of the seal bodies can slide respectively in a gas-tight axial manner, each have a circular cross section in geometric sectional planes passed through perpendicularly by the geometric piston axis. Other cross sections, in particular oval cross sections, are likewise possible, but are associated with increased manufacturing outlay depending on the production method.

A middle cylinder interior is formed between the first seal body and the second seal body and is located between the first and the second pressure chamber and is separated in a gas-tight manner from these two pressure chambers by the seal bodies. Since the volume of this middle cylinder interior alters as the distance between the two seal bodies changes, when one of the seal bodies is displaced, it must be possible to ventilate this middle cylinder interior. This can be obtained by means of an opening of the middle cylinder interior outwardly. In a possible embodiment of the invention the middle cylinder interior is ventilated by at least one ventilation duct leading from the middle cylinder interior, out from the cylinder unit, said ventilation duct leading in particular into the surrounding atmosphere.

By means of the limited free movability according to the invention of the two seal bodies, the cylinder unit can be moved relative to the piston unit into a stable, defined middle position, specifically the middle relative position between the first and the second relative position, by applying pressure, in particular by applying substantially the same pressure, to both pressure chambers.

The movement of the piston-cylinder arrangement into the three relative positions will be described hereinafter with reference to a stationary cylinder unit and a movable piston unit. However, a kinematic reversal with a movable cylinder unit and a stationary piston unit or a movable cylinder unit and a movable piston unit are also possible and included by the invention.

In particular the effective pressure application surfaces of the piston unit in the first pressure chamber and in the second pressure chamber are identical. In particular the effective pressure application surfaces of the first seal body in the first pressure chamber and of the second seal body in the second pressure chamber are identical. In particular the effective pressure application surfaces of the piston unit in the pressure chambers are larger than the effective pressure application surfaces of the seal bodies in the pressure chambers.

In the first relative position the piston unit is moved in the direction of the first pressure chamber. The volume of the first pressure chamber is reduced, in particular is at a minimum, and the volume of the second pressure chamber is increased, in particular is at a maximum. The pressure in the second pressure chamber is significantly increased, and in particular the pressure in the second pressure chamber is significantly greater than the pressure in the first pressure chamber. Due to the significantly relatively increased pressure in the second pressure chamber, the piston unit is pushed in the direction of the first pressure chamber and is held there in a stable manner in the first relative position. In particular in the second pressure chamber, in particular in both pressure chambers, a relative overpressure prevails relative to the pressure in the middle cylinder interior, in particular relative to the surrounding atmosphere, such that in particular both seal units are pushed toward one another, i.e. in a direction toward the first and second axial stops respectively.

The first seal body rests on the third axial stop of the piston unit. The pressure in the first pressure chamber thus acts on the piston unit in the direction of the second pressure chamber both via the effective pressure application surface of the piston unit and via the effective pressure application surface of the first seal body. The second seal body, however, rests on the second axial stop of the cylinder unit. The pressure in the second pressure chamber thus acts on the piston unit in the direction of the first pressure chamber only via the effective pressure application surface of the piston unit, and not via the second seal body, since this is supported on the cylinder unit via the second axial stop.

In the first relative position (and in the region between the first relative position and the middle relative position) the effective pressure application surface in the first pressure chamber acting on the piston unit is thus larger than the effective pressure application surface in the second pressure chamber acting on the piston unit, since the effective pressure application surface of the first seal body also acts on the piston unit on the side of the first pressure chamber.

The arrangement of the second portion of the outer peripheral surface of the piston unit and of the second axial stop of the cylinder unit is thus such that, within this region between the first relative position and the middle relative position, the second seal body is stationary via its outer sealing surface relative to the second portion of the inner peripheral surface of the piston unit, since said second seal body bears against the second axial stop, whereas, when the piston unit moves, the second portion of the outer peripheral surface of the piston unit slides over the inner sealing surface of the second seal body. The arrangement of the first portion of the inner peripheral surface of the cylinder unit and of the third axial stop of the piston unit is in particular such that the first seal body, within this region, is stationary via its inner sealing surface relative to the first portion of the outer peripheral surface of the piston unit, since said first seal body bears against the third axial stop, whereas, when the piston unit moves, the first seal body slides via its outer sealing surface over the first portion of the inner peripheral surface of the cylinder unit.

So that the piston unit thus moves from the middle relative position into the first relative position and is held in this first relative position, the pressure in the second pressure chamber must be significantly relatively increased, since the effective pressure application surface in the second pressure chamber acting on the piston unit is reduced in the movement region between the middle and the first relative position.

In the second relative position, in which the piston unit is moved in the direction of the second pressure chamber, the situation is reversed accordingly. The volume of the second pressure chamber is reduced, in particular is at a minimum, and the volume of the first pressure chamber is increased, in particular is at a maximum. The pressure in the first pressure chamber is increased significantly relative to the pressure in the second pressure chamber, and in particular the pressure in the first pressure chamber is significantly greater than the pressure in the second pressure chamber. Due to the significantly relatively increased pressure in the first pressure chamber, the piston unit is pushed in the direction of the second pressure chamber and is held there in a stable manner in the second relative position.

The second seal body rests on the fourth axial stop of the piston unit. The pressure in the second pressure chamber thus acts on the piston unit in the direction of the first pressure chamber both via the effective pressure application surface of the piston unit and via the effective pressure application surface of the second seal body. However, the first seal body rests on the first axial stop of the cylinder unit. The pressure in the first pressure chamber thus acts on the piston unit in the direction of the second pressure chamber only via the effective pressure application surface of the piston unit, and not via the first seal body, since this is supported on the cylinder unit via the first axial stop.

In the second relative position (and in the region between the second relative position and the middle relative position), the effective pressure application surface in the second pressure chamber acting on the piston unit is thus larger than the effective pressure application surface in the first pressure chamber acting on the piston unit.

The arrangement of the first portion of the outer peripheral surface of the piston unit and of the first axial stop of the cylinder unit is thus such that, within this region between the second relative position and the middle relative position, the first seal body is stationary via its outer sealing surface relative to the first portion of the inner peripheral surface of the piston unit, since said first seal body bears against the first axial stop, whereas, when the piston unit moves, the first portion of the outer peripheral surface of the piston unit slides over the inner sealing surface of the first seal body. The arrangement of the second portion of the inner peripheral surface of the cylinder unit and of the fourth axial stop of the piston unit is in particular such that the second seal body, within this region, is stationary via its inner sealing surface relative to the second portion of the outer peripheral surface of the piston unit, since said second seal body bears against the fourth axial stop, whereas, when the piston unit moves, the second seal body slides via its outer sealing surface over the second portion of the inner peripheral surface of the cylinder unit.

So that the piston unit thus moves from the middle relative position into the second relative position and is held in this second relative position, the pressure in the first pressure chamber must be significantly relatively increased, since the effective pressure application surface in the first pressure chamber acting on the piston unit is reduced in the movement region between the middle and the second relative position.

This described arrangement of the axial stops, seal bodies and peripheral surfaces means that, in order to move the piston unit from the middle relative position in the direction of the first or opposite second relative position, a significant relative pressure increase is necessary in one of the two pressure chambers, since, when the middle relative position is left, the force acting in opposition is increased on account of the larger effective pressure application surface. The piston unit is thus in a stable equilibrium in the middle relative position. Within a large (depending on the ratio of the pressure application surfaces of the seal bodies and of the piston unit) range of a differential pressure between the first pressure chamber and the second pressure chamber, the piston unit remains in the middle relative position in a stable manner. Only when this large middle pressured differential range is exceeded or undershot is the piston moved into the first or second relative position.

It is thus possible by means of a simple, in particular pneumatic control unit, to move the piston unit between the first relative position, the second relative position and the middle relative position by applying a relative overpressure to the first and the second pressure chamber alternately or simultaneously, wherein the respective positions are held in a stable manner. In the first and second relative position the pressure chamber not acted on by increased pressure is either connected in a pressureless manner to the atmosphere or is acted on by a significantly lower pressure (relative to the increased pressure of the opposite pressure chamber). The application of a lower counter pressure is not absolutely necessary in all applications, but is advantageous in certain applications for damping reasons and in order to relieve and protect the seal bodies, in particular in order to hold the seal bodies at the respective axial stop.

The vacuum valve according to the invention, in a variant of the invention, has a first valve wall, which has a first opening and a first valve seat running around the first opening.

This vacuum valve is used by way of example for the gas-tight closure of a flow path and preferably comprises a valve body having the first valve wall, which has the first opening for the flow path. The flow path is to be understood generally to mean an opening path between two regions that is to be closed.

The first opening may have an arbitrary cross section, in particular a rectangular, circular or oval cross section. If the vacuum valve is a transfer valve, it preferably has an elongate, in particular substantially rectangular, opening cross section, wherein the width of the opening is preferably at least twice or at least three times or at least five times the height of the opening. It is also possible, however, to form the opening cross section differently, for example in a circular manner, wherein the vacuum valve is a pump valve, for example. The opening has a central axis, which extends in the region of the opening in the middle of the flow path parallel thereto. This geometric opening axis is arranged for example perpendicularly to the surface spanned by the opening and extends along the flow path.

The first closure member in this variant of the invention has a first closure side for the substantially gas-tight closure of the first opening. The first drive with the above-described piston-cylinder arrangement is formed and is coupled to the first closure member in such a way that the first closure member can be moved by means of the first drive (in the form of what is known as a longitudinal movement) perpendicularly to the first valve seat between the second closure member position, which corresponds to the second relative position of the cylinder and piston unit, the middle closure member position, which corresponds to the middle relative position, and the first closure member position, which corresponds to the first relative position. In the second closure member position the first closure side is located opposite and at a distance from the first valve seat. In the first closure member position this distance is reduced to a minimum and the first closure side is pressed substantially perpendicularly against the first valve seat, wherein the first opening and therefore the flow path is closed substantially in a gas-tight manner by the first closure side.

In the middle closure member position the first closure side, in a variant, is likewise located opposite and at a distance from the first valve seat, wherein the distance from the first valve seat in the second closure member position is greater than in the middle closure member position. In this case the drive according to the invention acts, provided the vacuum valve has just one opening to be closed, as a two-stage longitudinal drive for moving the first closure member in a perpendicular direction toward the first valve seat, wherein the opening cross section can be reduced in two stages.

Alternatively the first closure side is also to pressed substantially perpendicularly against the first valve seat in the middle closure member position, wherein the first opening and therefore the flow path is closed substantially in a gas-tight manner by the first closure side. In this case, however, the pressing force against the valve seat in the middle closure member position is reduced, wherein, by changing from the middle to the first closure member position, it is possible to switch from a lower to a higher pressing force against the main seal of the valve, which seal in particular is resilient, for example in the event of an increased pressure difference at the first closure member.

In a development of the invention the vacuum valve is formed as what is known as a double valve. The vacuum valve has a second valve wall arranged opposite and at a distance from the first valve wall, which second valve wall has a second opening and a second valve seat running around the second opening and arranged opposite and at a distance from the first valve seat. In addition, the vacuum valve has a second closure member. The second closure member has a second closure side pointing in a direction opposite the first closure side in order to close the second opening in a substantially gas-tight manner. The second closure member is mechanically coupled to the first closure member and can be moved jointly with the first closure member by means of the at least one piston-cylinder arrangement. In particular the two closure members are formed by two closure plates arranged opposite and at a distance from one another. It is also possible, however, that the first closure member and the second closure member are formed by a single closure member that has two opposite closure sides.

By means of the piston-cylinder arrangement both the first closure member and the second closure member can be moved via the second closure side thereof between the first closure member position, the middle closure member position, and the second closure member position.

In the first closure member position the second closure side of the second closure member is located opposite and at a distance from the second valve seat, whereas the distance between the first closure member and the first valve seat is reduced to a minimum and the first closure side is pressed substantially perpendicularly against the first valve seat, wherein the first opening is closed in a gas-tight manner by the first closure side of the first closure member. In the middle closure member position the first closure side and the second closure side are located opposite and at a distance from the first and second valve seats respectively. In the second closure member position the second closure side is pressed substantially perpendicularly against the second valve seat and closes the second opening substantially in a gas-tight manner, whereas the first closure side of the first closure member is located opposite and at a distance from the first valve seat.

It is possible that, instead of a single piston-cylinder arrangement, a plurality of piston-cylinder arrangements arranged in particular parallel to one another are used. For example, in particular in the case of a double valve, four piston-cylinder arrangements arranged rectangularly relative to one another may be positioned in the corner regions of the two, in particular rectangular, closure members, whereby a high stability is achieved. The respective first and second pressure chambers may be connected to each other, or the piston-cylinder arrangements connected in parallel may share a common first and a common second pressure chamber.

In a development of this double valve according to the invention a first piston rod guided through the first pressure chamber and guided out in a gas-tight manner axially movably from the cylinder unit and a second piston rod guided through the second pressure chamber and guided out in a gas-tight manner axially movably from the cylinder unit are arranged on the piston unit. The first closure member is located on the end of the first piston rod guided out through the cylinder unit. The second closure member is arranged on the end of the second piston rod guided out through the cylinder unit. The above-described piston-cylinder arrangement according to the invention is located between the first closure side and the second closure side, in particular between the two closure plates.

In accordance with a continuation of the invention the piston-cylinder arrangement is arranged on a connecting rod, wherein the first closure member and in particular also the second closure member can be moved relative to this connecting rod. In particular the piston-cylinder arrangement serves as a longitudinal drive for moving the at least one closure member in a direction perpendicular to the respective valve seat, wherein the connecting rod with the piston-cylinder arrangement and the at least one closure member on the other hand can be moved transversely to the respective valve seat, by means of a second drive acting as a transverse drive.

For this purpose a first portion of the connecting rod is coupled to the piston-cylinder arrangement, and a second portion of the connecting rod is coupled to a second drive. The first portion of the connecting rod by way of example is the first end, and the second portion of the connecting rod by way of example is the second end of the connecting rod, which in particular may be formed as a push rod or pivot rod or arm.

In a further continuation of the invention the above-described connecting rod has a first pressure line and a second pressure line, which each extend between the first portion and the second portion and which are formed in particular by channels extending in the connecting rod. The first pressure line leads in the first portion into the first pressure chamber and in the second portion to a first pressure connection. The second pressure line leads in the first portion into the second pressure chamber and in the second portion to a second pressure connection.

The second drive is formed and is coupled to the least one connecting rod in such a way that the piston-cylinder arrangement and the first closure member can be moved, in particular transversely to the geometric piston axis, along a longitudinal axis of movement, or can be pivoted about a pivot axis.

The second drive, in a development of the invention, is formed and coupled to the connecting rod in such a way that the first closure member can be moved by means of the second drive transversely to the first valve seat and in particular also to the second valve seat between an open position and the intermediate position. In the open position the first closure member releases the first opening and in particular the second opening. In the intermediate position the first closure member covers the first opening and in particular the second closure member covers the second opening, wherein the first closure side is located opposite the first valve seat and in particular the second closure side is located opposite the second valve seat, as described above.

The second drive may be formed in particular as a linear drive for the linear movement of the first closure member transversely to the first valve seat between the open position and the intermediate position along a longitudinal axis of movement, wherein the vacuum valve in particular is a gate valve. This second drive formed as a linear drive may be formed by a conventional piston-cylinder arrangement, an electric linear drive, another linear drive, or the above-described piston-cylinder arrangement according to the invention.

Alternatively, the second drive may be a pivot drive for pivoting the first closure member transversely to the first valve seat between the open position and the intermediate position about a pivot axis, wherein the vacuum valve is formed in particular as a shuttle valve. Not only in particular are electric pivot drives suitable as a pivot drive, but also linear drives connected to a pivot arm, in particular also conventional piston-cylinder arrangements, but also the piston-cylinder arrangement according to the invention.

The first drive having the piston-cylinder arrangement according to the invention may be arranged not only, as described above, in the vacuum region of the vacuum valve, in particular directly on the closure member, for example between the first and the second closure member, but also outside the vacuum region of the vacuum valve, for example in a drive housing. In this case the piston-cylinder arrangement arranged outside the vacuum region is connected by way of example to a connecting rod, which is guided into the vacuum region of the vacuum valve in a manner providing gas-tight sealing, wherein the first closure member, in particular also the second closure member, are arranged at the other end of the connecting rod. This piston-cylinder arrangement may form the longitudinal or transverse drive of the vacuum valve.

The above-described flow path leading through the first opening and in particular also through the second opening is, for example, a connecting passage between two interconnected process chambers, wherein the process chambers may be opened by means of the vacuum valve in order to transfer the semiconductor parts from one process chamber to the next and may then be closed in a gas-tight manner in order to perform the respective manufacturing step. Gate valves of this type are also referred to as vacuum transfer valves on account of the described field of application and are also referred to as rectangular gates on account of their usually rectangular opening cross section.

However, any other arbitrary application of the vacuum valve according to the invention in particular for the substantially gas-tight closure of any flow path is of course also possible.

The vacuum valve according to the invention will be described by way of example hereinafter purely by way of example with reference to specific exemplary embodiments illustrated schematically in the drawings.

In the drawings:

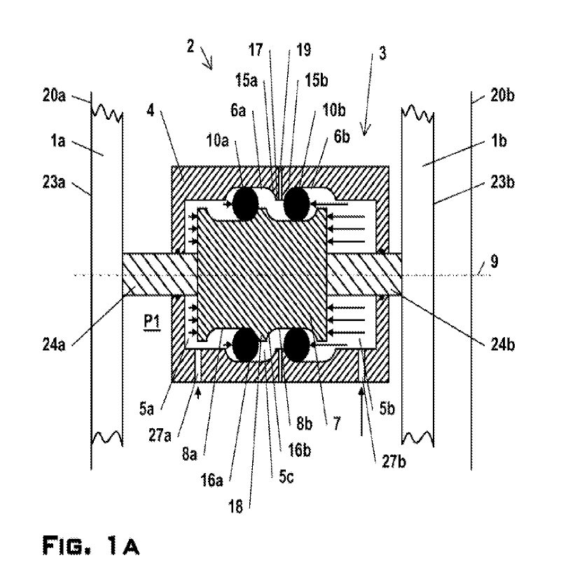

FIG. 1a shows a first embodiment of the piston-cylinder arrangement of the vacuum valve with a first and a second O-ring in a schematic detailed view in a first relative position;

FIG. 1b shows the first embodiment from FIG. 1a in a middle relative position;

FIG. 1c shows the first embodiment from FIG. 1a in a second relative position;

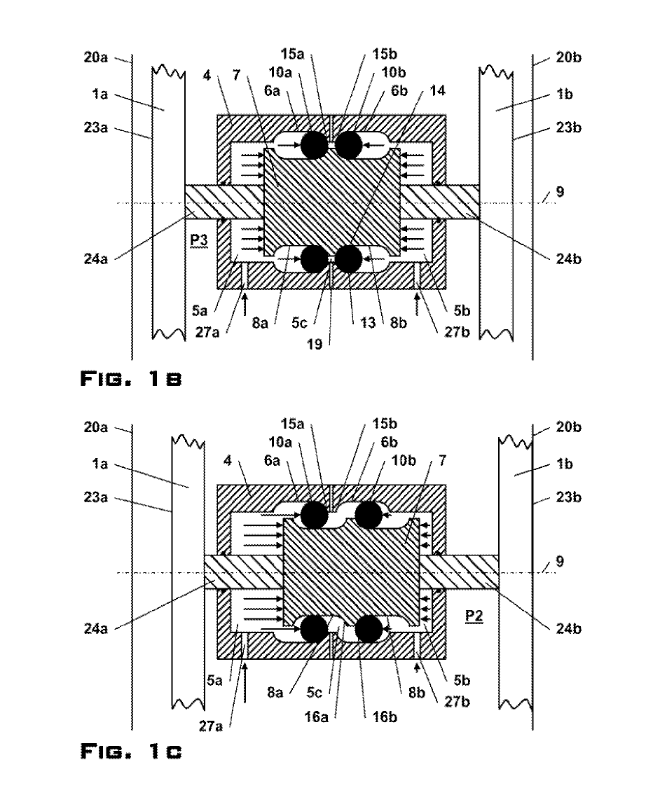

FIG. 2a shows a second embodiment of the piston-cylinder arrangement of the vacuum valve with a first and a second seal carrier in a schematic detailed view in a first relative position;

FIG. 2b shows the second embodiment from FIG. 2a in a middle relative position;

FIG. 2c shows the second embodiment from FIG. 2a in a second relative position;

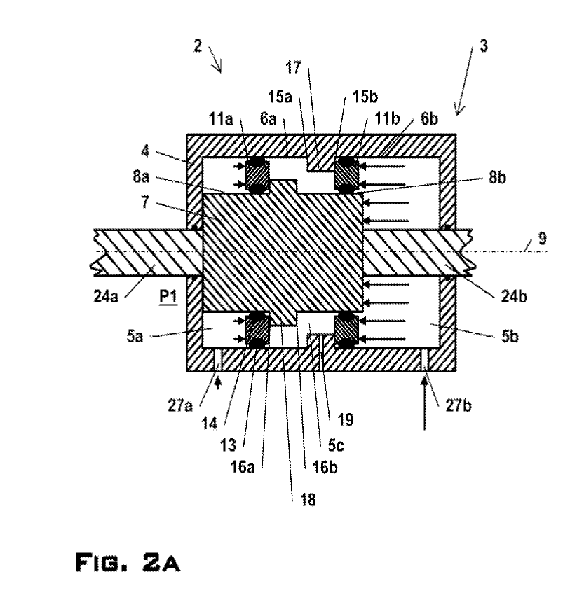

FIG. 3a shows a vacuum valve according to the invention in a longitudinal section in an open position;

FIG. 3b shows the vacuum valve in a middle cross section through the connecting rod in the open position;

FIG. 3c shows the vacuum valve in a lateral cross section through the piston-cylinder arrangement in the open position;

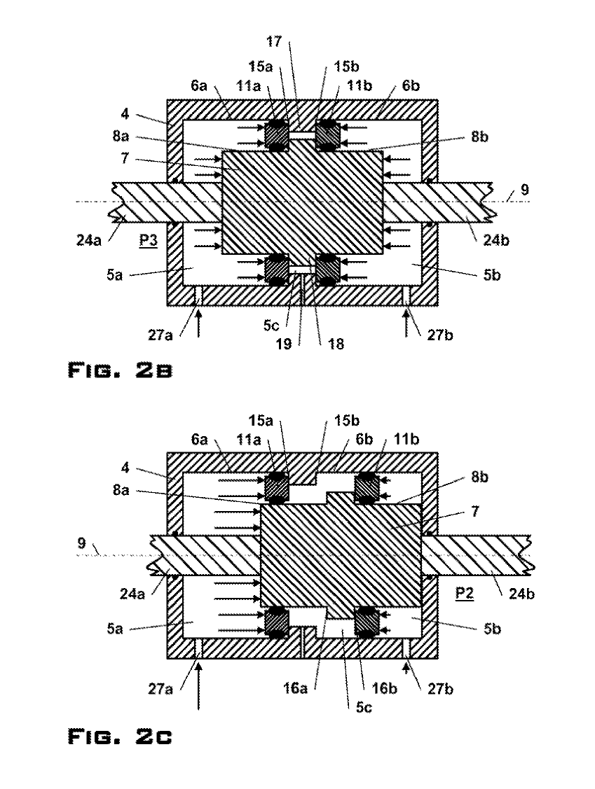

FIG. 4a shows the vacuum valve in the longitudinal section in an intermediate position;

FIG. 4b shows the vacuum valve in the middle cross section through the connecting rod in the intermediate position;

FIG. 4c shows the vacuum valve in the lateral cross section through the piston-cylinder arrangement in the intermediate position;

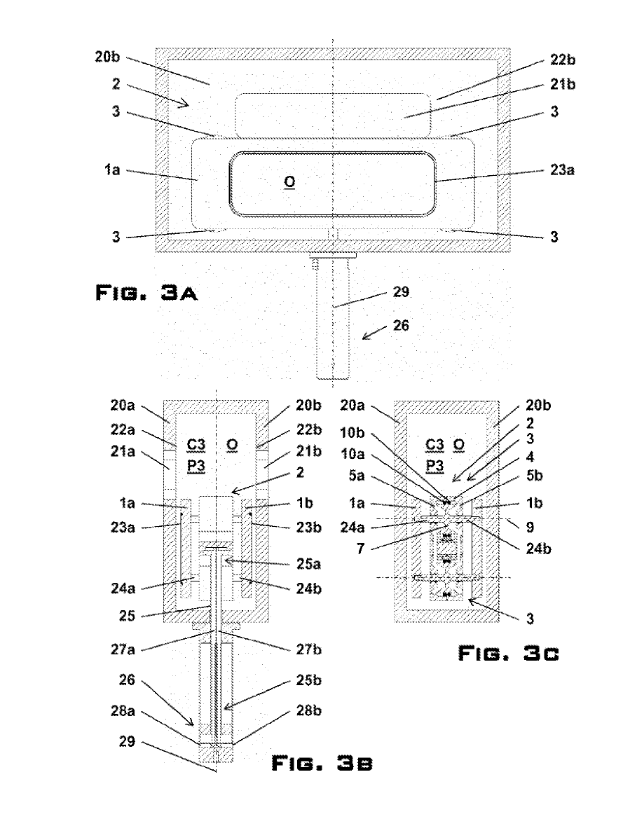

FIG. 5a shows the vacuum valve in the middle cross section through the connecting rod in a first closure member position;

FIG. 5b shows the vacuum valve in the lateral cross section through the piston-cylinder arrangement in the first closure member position;

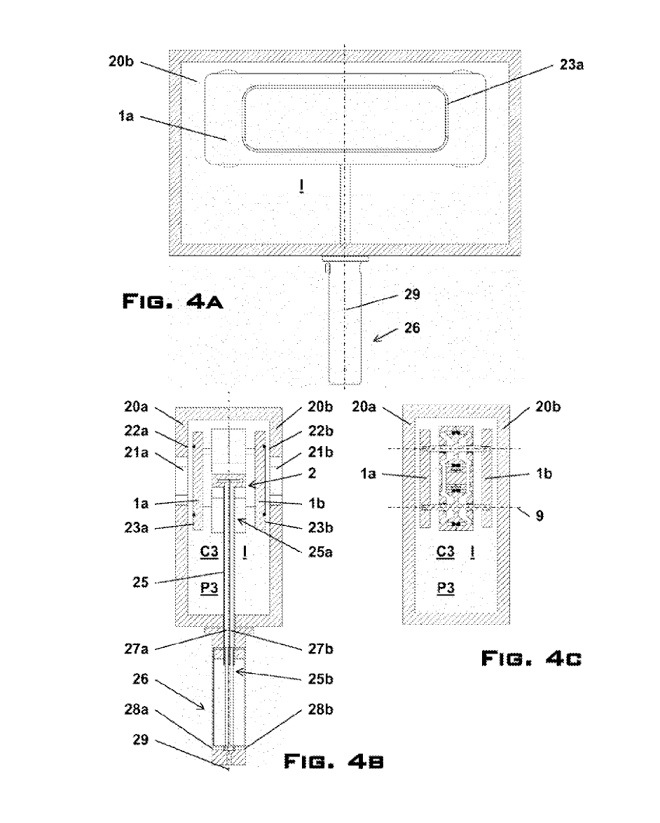

FIG. 6a shows the vacuum valve in the middle cross section through the connecting rod in a second closure member position; and

FIG. 6b shows the vacuum valve in the lateral cross section through the piston-cylinder arrangement in the second closure member position.

The groups of figures formed of FIGS. 1a, 1b, 1c, of FIGS. 2a, 2b, 2c, and of FIGS. 3a, 3b, 3c, 4a, 4b, 4c, 5a, 5b, 6a and 6b each show a common exemplary embodiment of a piston-cylinder arrangement according to the invention or of a vacuum valve according to the invention in different states, from different views, and in different levels of detail. The embodiments differ from one another merely in respect of certain features, and therefore the embodiments and/or the groups of figures will be described jointly in part, and therefore sometimes only the differences between the embodiments will be discussed. Some reference signs and features already explained in previous figures will not be discussed again. In addition, it should be noted that FIGS. 1a to 2c show schematic illustrations in which some of the components, for improved clarity, are arranged and illustrated differently compared with the detailed illustrations in FIGS. 3a to 6b. The schematic illustrations of the piston-cylinder arrangements in FIGS. 1a to 2c and also the explanations thereof are therefore also to be applied to the exemplary embodiment of the vacuum valve shown in FIGS. 3a to 6b.

FIGS. 3a to 6b show a vacuum valve in the form of a double valve formed as a gate valve or transfer valve. The vacuum valve has a first valve wall 20a, which has a first opening 21a and a first valve seat 22a running around the first opening 21a. Opposite and at a distance from the first valve wall 20a, a second valve wall 20b is provided, which has a second opening 21b and a second valve seat 22b running around the second opening 21b and arranged opposite and at a distance from the first valve seat 22a, as shown in FIGS. 3b and 3c. The two openings 21a and 21b have a substantially rectangular cross section, as can be seen in FIG. 3a. The valve walls 20a and 20b span a vacuum-tight valve body having two openings, specifically the openings 21a and 21b. These two openings 21a and 21b may be closed alternately by means of two closure members 1a and 1b.

The first closure member 1a has a first closure side 23a, FIG. 3b, for the substantially gas-tight closure of the first opening 21a. For this purpose a seal corresponding to the shape of the first valve seat 22a is vulcanized on the first closure side 23a. The second closure member 1b likewise has a second closure side 23b, which points in the direction opposite the first closure side 23a, for the substantially gas-tight closure of the second opening 21b. The second closure member 1b is mechanically coupled to the first closure member 1a via four piston rods 24a, 24b and can be moved jointly with the first closure member 1a.

For the joint movement of the two closure members 1a and 1b, the vacuum valve has two independent linear drives, specifically a first drive 2, FIGS. 3a to 3c, which acts as a longitudinal drive, and a second drive 26, FIGS. 3a to 3c, which acts as a transverse drive.

The second drive 26 is formed as a linear drive in the form of a piston-cylinder arrangement. This second drive 26 is arranged outside the vacuum region of the vacuum valve and outside the valve body. By means of the second drive 26, a connecting rod 25, which is guided in a gas-tight manner into the vacuum region of the vacuum valve, can be moved linearly along a longitudinal axis of movement 29, FIG. 3a. The first drive 2, which comprises four piston-cylinder arrangements 3, is arranged on an upper first portion 25a of the connecting rod 25, whereas a second portion 25b of the connecting rod 25 is coupled to the second drive 26, as shown in FIG. 3b.

By means of the second drive 26, the first closure member 1a, the second closure member 1b, and the first drive 2 may be moved linearly transversely to the first valve seat 22a and to the second valve seat 22b and transversely to the openings 21a, 21b between an open position O, FIGS. 3a to 3c, and an intermediate position I, FIGS. 4a to 4c, along the longitudinal axis of movement 29. The second drive 26 is thus formed and coupled to the at least one connecting rod 25 in such a way that the piston-cylinder arrangements 3 and the closure members 1a and 1b can be moved transversely to the geometric piston axes 9 along the longitudinal axis of movement 29. In the open position O shown in FIGS. 3a to 3c the first closure member 1a and the second closure member 1b completely release both the first opening 21a and the second opening 21b, such that the flow path through the openings 21a and 21b of the vacuum valve is completely open. In the intermediate position I shown in FIGS. 4a to 4c the first closure member 1a covers the first opening 21a, and the second closure member 1b covers the second opening 21b, wherein the first closure side 23a is located opposite the first valve seat 22a, and the second closure side 23b is located opposite the second valve seat 22b.

The first drive 2, as will be presented hereinafter, is formed and coupled to the closure members 1a and 1b in such a way that the first closure member 1a and the second closure member 1b can be moved in the intermediate position I by means of the first drive 2 perpendicularly to the first valve seat 22a and to the second valve seat 22b along geometric piston axes 9 between a middle closure member position C3, FIGS. 4a to 4c, a first closure member position C1, FIGS. 5a and 5b, and also a second closure member position C2, FIGS. 6a and 6b.

In the middle closure member position C3 shown in FIGS. 4a to 4c, both the first closure side 23a of the first closure member 1a, and the second closure side 23b of the second closure member 1b are located opposite and at a distance from the valve seats 22a and 22b respectively, wherein the first opening 21a and the second opening 21b are covered by the closure members 1a and 1b, but are not closed in a gas-tight manner as shown in FIGS. 4a to 4c.

In the first closure member position C1, FIGS. 5a and 5b, the first closure side 23a of the first closure member 1a is pressed by means of the first drive 2 substantially perpendicularly against the first valve seat 22a, such that the first opening 21a is closed by the first closure member 1a substantially in a gas-tight manner, whereas the second closure side 23b of the second closure member 1b is located opposite and at a distance from the second valve seat 22b, such that the second opening 21b is not closed in a gas-tight manner. This first closure member position C1 is suitable in particular for an operating mode in which a relative negative pressure is present on the side of the first opening 21a, since in this case the first closure member 1a is held against the first valve seat 22a on account of the pressure difference, without any force acting on the first drive 2.

In the second closure member position C2, illustrated in FIGS. 6a and 6b, the second closure side 23b of the second closure member 1b is pressed by means of the first drive 2 substantially perpendicularly against the second valve seat 22b, whereby the second opening 21b is closed substantially in a gas-tight manner, whereas in this second closure member position C2 the first closure side 23a of the first closure member 1a is located opposite and at a distance from the first valve seat 22a. This second closure member position C2 is suitable in particular for an operating mode in which a relative negative pressure is present on the side of the second opening 21b, since in this case the second closure member 1b is held against the second valve seat 22b on account of the pressure difference, without any force acting on the first drive 2.

The first drive 2 according to the invention will be described hereinafter in greater detail.

The first drive 2 comprises four piston-cylinder arrangements 3 arranged parallel to one another in a rectangle in the corner regions between the two closure members 1a and 1b in order to simultaneously move both closure members 1a and 1b in a perpendicular direction relative to the valve seats 22a and 22b and along the respective piston axis 9 relative to the connecting rod 25, as shown in FIGS. 3a to 6b.

Each of the piston-cylinder arrangements 3 has a cylinder unit 4, fixedly coupled to the connecting rod 25, and a linearly movable piston unit 7, as shown in FIGS. 1a to 2c and FIGS. 3b and 3c. The construction of the piston-cylinder arrangements 3 will be explained hereinafter on the basis of a single piston-cylinder arrangement 3.

The cylinder unit 4 has an inner peripheral surface 6a and 6b and also a cylinder interior 5a, 5b, 5c. The piston unit 7 has an outer peripheral surface 8a, 8b. The piston unit 7 is movable in the cylinder interior 5a, 5b, 5c linearly relative to the cylinder unit 4 along the geometric piston axis 9.

Two seal units, in FIGS. 1a to 1c and 3a to 6b the seal units 10a and 10b, in FIGS. 2a to 2c the seal units 11a and 11b, are arranged sealingly between the inner peripheral surface 6a, 6b and the outer peripheral surface 8a, 8b. Jointly with the piston unit 7, the seal units 10, 10b and 11a, 11b divide the cylinder interior into a gas-tight first pressure chamber 5a and a gas-tight second pressure chamber 5b, which is separated in a gas-tight manner from the first pressure chamber 5a.

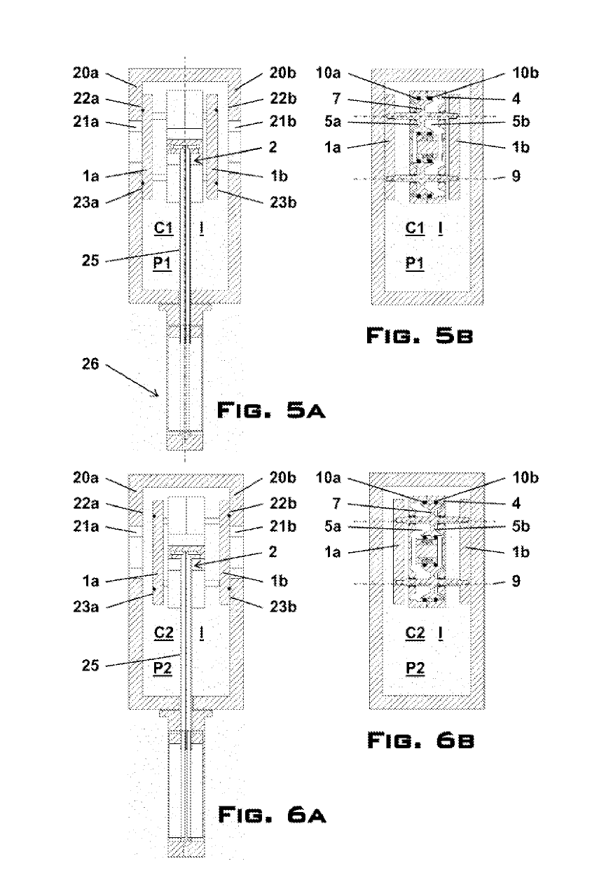

In accordance with the invention the seal units are formed by a first seal body 10a (FIGS. 1a to 1c and 3a to 6b) or 11a (FIGS. 2a to 2c) and a second seal body 10b (FIGS. 1a to 1c and 3a to 6b) or 11b (FIGS. 2a to 2c).

In the embodiments in FIGS. 1a to 1c and 3a to 6b the first seal body is formed by a first O-ring 10a and the second seal body is formed by a second O-ring 10b. These O-rings 10a and 10b have a circular cross section. The O-rings 10a and 10b form an outer seal 13 with respect to the inner peripheral surface 6a and 6b and also an inner seal 14 with respect to the outer peripheral surface 8a and 8b.

In the embodiments in FIGS. 2a to 2c the first seal body is a first seal carrier 11a having an outer seal 13, which forms an outer sealing surface, and an inner seal 14, which forms an inner sealing surface. The second seal body is a second seal carrier 11b, likewise having an outer seal 13, which forms the outer sealing surface, and an inner seal 14 forming the inner sealing surface. The seal carriers 11a and 11b have a ring shape, wherein the outer seal 13 and the inner seal 14 are provided in the form of O-rings, which are each held in respective grooves in each of the seal carriers 11a and 11b, or are provided in the form of seals that have been vulcanized on.

These two different variants will be described jointly hereinafter, wherein merely the differences of these embodiments will be discussed, and the first O-ring 10a and the second O-ring 10b and also the first seal carrier 11a and the second seal carrier 11b will be referred to as first seal bodies 10a, 11a and second seal bodies 10b, 11b respectively.

The first seal body 10a, 11a and the second seal body 10b, 11b are axially displaceable independently of one another relative to the cylinder unit 4 and to the piston unit 7 along the respective piston axis 9. In addition the first seal body 10a, 11a and the second seal body 10b, 11b each lie with the outer sealing surface 13 sealing in a gas-tight manner on the inner peripheral surface 6a, 6b and are axially displaceable relative to the inner peripheral surface 6a, 6b. Furthermore, the first seal body 10a, 11a and the second seal body 10b, 11b each lie with the inner sealing surface 14 sealing in a gas-tight manner against the outer peripheral surface 8a, 8b and are axially displaceable relative to the outer peripheral surface 8a, 8b.

A middle cylinder interior 5c, which is separated in a gas-tight manner from the first pressure chamber 5a and from the second pressure chamber 5b, and which is connected to the external atmosphere via a ventilation duct 19 leading out from the cylinder unit 4, is located between the first seal body 10a, 11a and the second seal body 10b, 11b.

The connecting rod 25 has a first pressure line 27a and a second pressure line 27b, which each extend between the first portion 25a and the second portion 25b of the connecting rod 25 and which are formed by ducts extending in the connecting rod 25, as shown in FIGS. 3b, 4b, 5a and 6a. The first pressure line 27a leads in the first portion 25a into the first pressure chamber 5a and leads in the second portion 25b to a first pressure connection 28a. The second pressure line 27b leads in the first portion 25a into the second pressure chamber 5b and leads in the second portion 25b to a second pressure connection 28b.

By changing a pressure difference between the first pressure chamber 5a and the second pressure chamber 5b, i.e. by applying different pressures at the pressure connections 28a and 28b, the piston unit 7 can be moved between a first relative position P1, FIGS. 1a, 2a, 5a and 5b, a middle relative position P3, FIGS. 1b, 2b and 3a to 4c, and a second relative position P2, FIGS. 1c, 2c, 6a and 6b.

A first piston rod 24a guided through the first pressure chamber 5a and a second piston rod 24b guided through the second pressure chamber 5b are each arranged on the respective piston unit 7. The two piston rods 24a and 24b are guided in a gas-tight manner axially movably out from the cylinder unit 4.

The first closure member 1a is fixed on the end of the first piston rod 24a guided out from the cylinder unit. The second closure member 1b is fixed on the end of the second piston rod 24b guided out from the cylinder unit. The piston-cylinder arrangements 3 are thus arranged between the first closure side 23a and the second closure side 23b of the closure members 1a and 1b.

The piston units 7 are thus mechanically coupled to the closure members 1a and 1b via the piston rods 24a and 24b. The first relative position P1 thus corresponds to the first closure member position C1, FIGS. 5a, 5b. The middle relative position P3 corresponds to the middle closure member position C3, FIGS. 3a to 4c. The second relative position P2 corresponds to the second closure member position C2, FIGS. 6a and 6b.

The inner peripheral surface 6a, 6b of the cylinder unit 4 is divided by a shoulder 17 protruding inwardly into the cylinder interior 5c into a first portion 6a of the inner peripheral surface and a second portion 6b of the inner peripheral surface. The inwardly protruding shoulder 17 forms a first axial stop 15a pointing toward the first pressure chamber 5a and the first seal body 10a, 11a and a second axial stop 15b pointing toward to the second pressure chamber 5b and the second seal body 10b, 11b.

The outer peripheral surface 8a, 8b of the piston unit 7 is also divided by an outwardly protruding shoulder into a first portion 8a of the outer peripheral surface and a second portion 8b of the outer peripheral surface. The outwardly protruding shoulder 18 forms a third axial stop 16a pointing toward the first pressure chamber 5a and the first seal body 10a, 11a and a fourth axial stop 16b pointing toward the second pressure chamber 5b and the second seal body 10b, 11b.

The first portion 6a and the second portion 6b of the inner peripheral surface and the first portion 8a and the second portion 8b of the outer peripheral surface each have a circular cross section in a geometric sectional plane passed through perpendicularly by the geometric piston axis 9.

The first axial stop 15a of the inwardly protruding shoulder 17 limits the axial movability of the first seal body 10a, 11a relative to the cylinder unit 4 in the direction of the second pressure chamber 5b to the first portion 6a of the inner peripheral surface arranged on the side of the first pressure chamber 5a.

The second axial stop 15b of the inwardly protruding shoulder 17 limits the axial movability of the second seal body 10b, 11b relative to the cylinder unit 4 in the direction of the first pressure chamber 5a to the second portion 6b of the inner peripheral surface arranged on the side of the second pressure chamber 5b.

The third axial stop 16a of the outwardly protruding shoulder 18 limits the axial movability of the first seal body 10a, 11a relative to the piston unit 7 in the direction of the second pressure chamber 5b to the first portion 8a of the outer peripheral surface arranged on the side of the first pressure chamber 5a.

The fourth axial stop 16b of the outwardly protruding shoulder 18 limits the axial movability of the second seal body 10b, 11b relative to the piston unit 7 in the direction of the first pressure chamber 5a to the second portion 8b of the outer peripheral surface arranged on the side of the second pressure chamber 5b.

In the middle relative position P3 the first axial stop 15a and the third axial stop 16a are arranged radially opposite one another with respect to the piston axis 9, FIGS. 1b, 2b, and 3a to 4c. On account of this axial opposite arrangement, the first axial stop 15a and the third axial stop 16a are arranged relative to one another in such a way that, in the middle relative position P3 of the cylinder unit 4, the axial movability of the first seal body 10a, 11a in the direction of the second pressure chamber 5b is limited jointly by the first axial stop 15a and the third axial stop 16a, as shown in FIGS. 1b, 2b, and 3a to 4c.

In addition, in this middle relative position P3, the second axial stop 15b and the fourth axial stop 16b are radially opposite one another with respect to the piston axis 9, as also shown in FIGS. 1b, 2b and 3a to 4c. On account of this axial opposite arrangement, the second axial stop 15b and the fourth axial stop 16b are also arranged relative to one another in such a way that, in the middle relative position P3, the axial movability of the second seal body 10b, 11b in the direction of the first pressure chamber 5a is limited jointly by the second axial stop 15b and the fourth axial stop 16b, as shown in FIGS. 1b, 2b and 3a to 4c.

In the embodiments in FIGS. 1a to 1c and 3a to 6b the inwardly protruding shoulder 17 has transitions to the first portion 6a of the inner peripheral surface and to the second portion 6b of the inner peripheral surface, said transitions corresponding to the shape of the first O-ring 10a and of the second O-ring 10b. The outwardly protruding shoulder 18 also has transitions to the first portion 8a of the outer peripheral surface and to the second portion 8b of the outer peripheral surface, said transitions corresponding to the shape of the first O-ring 10a and of the second O-ring 10b. These transitions of the inwardly protruding shoulder 17 and of the outwardly protruding shoulder 18 correspond substantially to the radius of the cross section of the O-rings 10a and 10b, such that these may come to rest uniformly on the axial stops 15a to 16b, whereby the O-rings 10a and 10b are subjected to a lower mechanical wear and the service life increases.

The limited free movability of the two seal bodies 10a, 10b, 11a, 11b means that the closure members 1a and 1b can be moved into a stable, defined middle position, specifically the middle closure member position C3 between the first closure member position C1 and the second closure member position C2 by applying pressure, in particular by applying substantially the same pressure, to both pressure chambers 5a and 5b.

In the first relative position P1, FIGS. 1a, 2a, 5a and 5b, the piston unit 7 is moved in the direction of the first pressure chamber 5a. The volume of the first pressure chamber 5a is at a minimum and the volume of the second pressure chamber 5b is at a maximum. The pressure in the second pressure chamber 5b is significantly greater than the pressure in the first pressure chamber 5a, as illustrated by the arrows. The first seal body 10a, 11a rests on the third axial stop 16a of the piston unit 7. The second seal body 10b, 11b, however, rests on the second axial stop 15b of the cylinder unit 4. In the first relative position P1 (and in the region between the first relative position P1 and the middle relative position P3) the effective pressure application surface in the first pressure chamber 5a acting on the piston unit 7 is thus larger than the effective pressure application surface in the second pressure chamber 5b acting on the piston unit 7, as can be seen in FIGS. 1a and 2a on the basis of the arrows.

Within this region between the first relative position P1 and the middle relative position P3, the second seal body 10b, 11b is stationary via its outer sealing surface 13 relative to the second portion of the inner peripheral surface 6b of the piston unit 4, since said outer sealing surface bears against the second axial stop 15b, whereas, when the piston unit 7 moves, the second portion 8b of the outer peripheral surface of the piston unit 7 slides over the inner sealing surface of the second seal body 10b, 11b, as shown in FIGS. 1a and 2a.

In the second relative position P2, FIGS. 1c, 2c, 6a and 6b, in which the piston unit 7 is moved in the direction of the second pressure chamber 5b, the situation is reversed accordingly. The volume of the second pressure chamber 5b is at a minimum, and the volume of the first pressure chamber 5a maximal. The pressure in the first pressure chamber 5a is significantly greater than the pressure in the second pressure chamber 5b, as indicated by the arrows. The second seal body 10b, 11b rests on the fourth axial stop 16b of the piston unit 7.

The pressure in the second pressure chamber 5b thus acts both via the effective pressure application surface of the piston unit 7 and via the effective pressure application surface of the second seal body 10b, 11b on the piston unit 7 in the direction of the first pressure chamber 5a. In the second relative position P2 (and in the region between the second relative position P3 and the middle relative position P3) the effective pressure application surface in the second pressure chamber 5b acting on the piston unit 7 is thus larger than the effective pressure application surface in the first pressure chamber 5a acting on the piston unit 7.

In order to move the piston unit 7 from the middle relative position P3 in the direction of the first or opposite second relative position P1 or P2, a significant relative pressure increase in one of the two pressure chambers is thus necessary, since, when the middle relative position P2 is left, the force acting in opposition is increased on account of the larger effective pressure application surface. The piston unit 2 is thus in a stable equilibrium in the middle relative position P2, FIGS. 1b, 2b, and 3a to 4c, provided the pressure in the two pressure chambers 5a and 5b is substantially identical within a large region and is higher than the pressure in the middle cylinder interior 5c and therefore higher than in the surrounding atmosphere.

By applying a relative overpressure alternately or simultaneously to the first pressure chamber 5a and the second pressure chamber 5b, it is possible by means of a simple pneumatic circuit, to move the piston unit 7 between the first relative position P1, the second relative position P2, and the middle relative position P3, and therefore also to move the closure members 1a and 1b between the first closure member position C1, the second closure member position C2, and the middle closure member position C3, wherein the respective positions are held in a stable manner.

1-15. (canceled)

16. A vacuum valve having a first closure member and a first drive, which has at least one piston-cylinder arrangement, for moving the first closure member,
wherein the at least one piston-cylinder arrangement
has a cylinder unit, which has a cylinder interior and an inner peripheral surface,
a piston unit, which has an outer peripheral surface and can be moved in the cylinder interior linearly relative to the cylinder unit along a geometric piston axis, and
a seal unit, which is arranged sealingly between the inner peripheral surface and the outer peripheral surface and which, jointly with the piston unit, divides the cylinder interior into a gas-tight first pressure chamber and a gas-tight second pressure chamber separated in a gas-tight manner from the first pressure chamber,
wherein the at least one piston-cylinder arrangement is mechanically coupled to the first closure member in such a way that the first closure member can be moved, by changing a pressure difference between the first pressure chamber and the second pressure chamber, between
a first closure member position, in which the cylinder unit and the piston unit are positioned relative to one another in a first relative position to one another, and
a second closure member position, in which the cylinder unit and the piston unit are positioned relative to one another in a second relative position to one another, wherein:
the seal unit is formed by a first seal body and a second seal body, wherein the seal bodies are axially displaceable independently of one another relative to the cylinder unit and to the piston unit along the piston axis,
each have an outer sealing surface bearing in a gas-tight manner against the inner peripheral surface and axially displaceable relative to the inner peripheral surface, and
each have an inner sealing surface bearing in a gas-tight manner on the outer peripheral surface and axially displaceable relative to the outer peripheral surface,
the cylinder unit has a first axial stop, which limits the axial movability of the first seal body relative to the cylinder unit in the direction of the second pressure chamber to a first portion of the inner peripheral surface arranged on the side of the first pressure chamber,
the cylinder unit has a second axial stop, which limits the axial movability of the second seal body relative to the cylinder unit in the direction of the first pressure chamber to a second portion of the inner peripheral surface arranged on the side of the second pressure chamber,
the piston unit has a third axial stop, which limits the axial movability of the first seal body relative to the piston unit in the direction of the second pressure chamber to a first portion of the outer peripheral surface arranged on the side of the first pressure chamber,
the piston unit has a fourth axial stop, which limits the axial movability of the second seal body relative to the piston unit in the direction of the first pressure chamber to a second portion of the outer peripheral surface arranged on the side of the second pressure chamber,
the first axial stop and the third axial stop are arranged relative to one another in such a way that, in a middle relative position of the cylinder unit and the piston unit relative to one another, said middle relative position lying between the first relative position and the second relative position and corresponding to a middle closure member position, the axial movability of the first seal body in the direction of the second pressure chamber is limited jointly by the first axial stop and the third axial stop,
and the second axial stop and the fourth axial stop are arranged relative to one another in such a way that, in the middle relative position, the axial movability of the second seal body in the direction of the first pressure chamber is limited jointly by the second axial stop and the fourth axial stop.

17. The vacuum valve as claimed in claim 16, wherein:
the first axial stop and the second axial stop of the cylinder unit are formed by at least one shoulder protruding inwardly into the cylinder interior, which shoulder is arranged between the first portion of the inner peripheral surface and the second portion of the inner peripheral surface.

18. The vacuum valve as claimed in claim 17, wherein:
the third axial stop and the fourth axial stop of the piston unit are formed by at least one outwardly protruding shoulder, which is arranged between the first portion of the outer peripheral surface and the second portion of the outer peripheral surface.

19. The vacuum valve as claimed in claim 18, wherein:
the first axial stop and the third axial stop and the second axial stop and the fourth axial stop in the middle relative position are arranged in each case radially opposite one another with respect to the piston axis.

20. The vacuum valve as claimed in claim 19, wherein:
the at least one inwardly protruding shoulder has transitions to the first portion of the inner peripheral surface and the second portion of the inner peripheral surface, said transitions corresponding to the shape of the first seal body and of the second seal body, and
the at least one outwardly protruding shoulder has transitions to the first portion of the outer peripheral surface and to the second portion of the outer peripheral surface, said transitions corresponding to the shape of the first seal body and of the second seal body.

21. The vacuum valve as claimed in claim 20, wherein:
the first seal body is formed by a first O-ring, and
the second seal body is formed by a second O-ring,
wherein the transitions of the inwardly protruding shoulder and of the outwardly protruding shoulder correspond substantially to the radius of the O-rings.

22. The vacuum valve as claimed in any one of claim 16, wherein:
the first seal body is formed by a first seal carrier having an outer seal forming the outer sealing surface and an inner seal forming the inner sealing surface, and
the second seal body is formed by a second seal carrier having an outer seal forming the outer sealing surface and an inner seal forming the inner sealing surface.

23. The vacuum valve as claimed in any one of claim 16, wherein:
the cylinder unit with its first portion and its second portion of the inner peripheral surface and the piston unit with its first portion and its second portion of the outer peripheral surface have a circular cross section in a geometric sectional plane passed through perpendicularly by the geometric piston axis.

24. The vacuum valve as claimed in any one of claim 16, wherein:
at least one ventilation duct leading out from the cylinder unit from a middle cylinder interior between the first seal body and the second seal body.

25. The vacuum valve as claimed in any one of claim 16, wherein:
a first valve wall, which has a first opening and a first valve seat running around the first opening, and
a first closure side of the first closure member for the substantially gas-tight closure of the first opening,
wherein the first drive is formed and coupled to the first closure member in such a way that the first closure member can be moved by means of the first drive perpendicularly to the first valve seat between
the second closure member position and the middle closure member position, in which the first closure side is located opposite and at a distance from the first valve seat, and
the first closure member position, in which the first closure side is pressed substantially perpendicularly against the first valve seat and closes the first opening in a substantially gas-tight manner.

26. The vacuum valve as claimed in claim 25, wherein:
a second valve wall arranged opposite and at a distance from the first valve wall, which second valve wall has a second opening and a second valve seat running around the second opening and being arranged opposite and at a distance from the first valve seat, and
a second closure member, which has a second closure side pointing in a direction opposite the first closure side in order to close the second opening in a substantially gas-tight manner, and which is mechanically coupled to the first closure member and can be moved jointly with the first closure member by means of the at least one piston-cylinder arrangement between
the first closure member position and the middle closure member position, in each of which the second closure side is located opposite and at a distance from the second valve seat, and
the second closure member position, in which the second closure side is pressed substantially perpendicularly against the second valve seat and closes the second opening in a substantially gas-tight manner.

27. The vacuum valve as claimed in claim 26, wherein:
a first piston rod guided through the first pressure chamber and guided out in a gas-tight manner axially movably from the cylinder unit and a second piston rod guided through the second pressure chamber and guided out in a gas-tight manner axially movably from the cylinder unit are arranged on the piston unit,
the first closure member is arranged on the end of the first piston rod guided out from the cylinder unit,
the second closure member is arranged on the end of the second piston rod guided out from the cylinder unit, and
the piston-cylinder arrangement is arranged between the first closure side and the second closure side.

28. The vacuum valve as claimed in claim 16, wherein:
a first portion of a connecting rod is coupled to the piston-cylinder arrangement and a second portion of the connecting rod is coupled to a second drive,
the connecting rod has a first pressure line and a second pressure line, which each extend between the first portion and the second portion and which are formed by ducts extending in the connecting rod,
the first pressure line leads in the first portion into the first pressure chamber and leads in the second portion to a first pressure connection,
the second pressure line leads in the first portion into the second pressure chamber and leads in the second portion to a second pressure connection, and
the second drive is formed and coupled to the at least one connecting rod in such a way that the piston-cylinder arrangement and the first closure member can be moved, transversely to the geometric piston axis.

29. The vacuum valve as claimed in claim 28, wherein the second drive is formed and coupled to the at least one connecting rod in such a way that the piston-cylinder arrangement and the first closure member can be pivoted about a pivot axis.

30. The vacuum valve as claimed in claim 28, wherein the second drive is formed and coupled to the at least one connecting rod in such a way that the piston-cylinder arrangement and the first closure member can be moved, transversely to the geometric piston axis, along a longitudinal axis of movement.

31. The vacuum valve as claimed in claim 28, wherein: the second drive is formed and coupled to the connecting rod in such a way that the first closure member can be moved by means of the second drive transversely to the first valve seat between
an open position, in which the first closure member releases the first opening, and
an intermediate position, in which the first closure member covers the first opening and the first closure side is located opposite the first valve seat.

32. The vacuum valve as claimed in claim 31, wherein:
the second drive is formed as a linear drive for linearly moving the first closure member transversely to the first valve seat between the open position and the intermediate position along a longitudinal axis of movement.

33. The vacuum valve as claimed in claim 32, wherein:
the vacuum valve is formed as a gate valve.

34. The vacuum valve as claimed in claim 31, wherein:
the second drive is formed as a pivot drive for pivoting the first closure member transversely to the first valve seat between the open position and the intermediate position about a pivot axis, and the vacuum valve is formed as a shuttle valve.
